(19) United States
(12) Patent Application Publication
(10) Pub. No.: US 2026/0116400 A1
(43) Pub. Date: Apr. 30, 2026

(54) METHOD FOR AN EMERGENCY STOP FOR INFRASTRUCTURE-CONNECTED VEHICLES

(71) Applicant: Robert Bosch GmbH, Stuttgart (DE)

(72) Inventors: Peter Sautter, Lauffen (DE); Nicolas Sommer, Remseck (DE); Vera Schumacher, Gerlingen (DE)

(21) Appl. No.: 19/364,036

(22) Filed: Oct. 21, 2025

(30) Foreign Application Priority Data
Oct. 29, 2024 (DE) 10 2024 210 399.3

(51) Int. Cl. B60W 50/00; B60W 50/14; B60W 60/00

(52) U.S. Cl. CPC B60W 50/0098; B60W 50/14; B60W 2050/0026; B60W 2050/146; B60W 60/0015; B60W 2556/45

(57) ABSTRACT

A method for an emergency stop function for infrastructure-connected vehicles. In the method, a configuration unit first creates a system-configuration-dependent transformation table from lookup tables corresponding to a current system configuration, with knowledge of a target, generic check table, wherein a lookup table is assigned to each emergency stop switch provided in the system configuration. During operation of the infrastructure-connected vehicles, an information-providing computing unit executes the following steps: receiving and/or reading the system-configuration-dependent transformation table from the configuration unit; receiving first signals of one or more emergency stop switches from an infrastructure; calculating a set of payload data from the first signals and by using the transformation table; and sending the calculated payload data to a computing platform of an infrastructure-connected vehicle. A computing platform arranged in an infrastructure-connected vehicle for controlling actuators is also described.

### FIELD

The present invention relates to a method for an emergency stop for infrastructure-connected vehicles.

### BACKGROUND INFORMATION

In the related art, emergency stop switches are a proven safety measure in various applications (e.g., production plants, machines, industrial trucks, vehicle prototype testing). Emergency stop switches are often wired, although there are also wireless versions that require associated, certified receiving hardware (HW). For some vehicle-based applications, in particular for vehicle functions that are controlled via a radio interface (e.g., Wi-Fi, 5G) (for example in automated valet parking (AVP)/automated vehicle maneuvering (AVM), reliable distributed systems (RDS), etc. ), no additional hardware is to be installed for implementing the emergency stop switch, since these are series-production vehicles. However, an emergency stop may be required for the overall system, including an infrastructure.

Germany Patent Application No. DE 10 2022 209 181 A1 describes a method for a remote control request of an autonomous vehicle that has a processor, which is configured to determine whether the autonomous vehicle is in a state in which performing the remote control is possible. In this context, the processor may deactivate (disengage) the autonomous driving mode or the remote control mode and switch to a manual driving mode if a driver provides any actuation of a steering device or an acceleration or deceleration device, or if, during an autonomous driving mode or a remote control mode, the driver actuates an emergency disengagement button for autonomous driving.

Europe Patent Application No. EP 3756929A1 describes a device for autonomous vehicle speed control that is provided in an autonomous vehicle. Further disclosed is a mechanical emergency stop operating unit for entering a stop command for the autonomous vehicle, wherein a vehicle speed control unit can cause the autonomous vehicle to stop by giving priority to the stop instruction entered via the emergency stop operating unit over vehicle speed control instructions entered via the touch panel and the mechanical operating unit.

Europe Patent Application No. EP 3855273A1 describes a system for controlling a plurality of autonomous vehicles at a mine site, in which a centralized platform comprises a complete list of vehicles and portable devices in an environment (factory premises). Furthermore, the portable device displays all of the vehicles within a radius of the portable device, and a user of the portable device can select one or more of the displayed vehicles to disable propulsion of only the selected vehicle(s).

### SUMMARY

It is an object of the present invention to provide a reliable method for operating an infrastructure system for driving assistance of connected motor vehicles guided in an at least semi-automated manner.

It is a further object of the present invention to provide an infrastructure system for driving assistance of connected motor vehicles guided in an at least semi-automated manner, which infrastructure system has a high level of reliability.

According to a first aspect of the present invention, a method for an emergency stop function for infrastructure-connected vehicles is provided.

According to an example embodiment of the present invention, the method provides that a configuration unit first creates a system-configuration-dependent transformation table from lookup tables corresponding to a current system configuration, with knowledge of a target, generic check table, wherein a lookup table is assigned to each emergency stop switch provided in the system configuration. The generic check table is predetermined and may, in particular, have variants (e.g., manufacturer-specific ones).

According to an example embodiment of the present invention, during operation of the infrastructure-connected vehicles, an information-providing computing unit executes the following steps:
a) receiving and/or reading the system-configuration-dependent transformation table from the configuration unit,
b) receiving first signals of one or more emergency stop switches from an infrastructure,
c) calculating a set of payload data from the first signals and by using the transformation table,
d) sending the calculated payload data to one computing platform each of one or more infrastructure-connected vehicles.

According to an example embodiment of the present invention, a computing platform arranged in an infrastructure-connected vehicle for controlling actuators executes the following steps:
e) receiving the calculated payload data from the information-providing computing unit,
f) providing a configuration-independent check table,
g) evaluating the payload data by using the check table and, in doing so, checking the validity of the payload data;
h) upon determining invalidity, performing a predefined safety maneuver.

In particular, the configuration unit is only required for configuration and may be offline during operation (as soon as the current transformation table has been read or received by the information-providing computing unit).

The method according to the present invention advantageously makes it possible to provide an extensible, hardware-independent emergency stop method that, in particular, does not require a dedicated transmitter/receiver in the vehicle. The integration of additional emergency stop switches and the replacement or modification of the configuration are thus particularly easy since only the transformation table needs to be adapted and no update (hardware or software) is required for the vehicles involved, so that safe operation of the infrastructure is ensured even in the event of a reconfiguration in response to the actuation of an emergency stop switch.

The predefined safety maneuver preferably comprises immediately stopping of one, several or all of the vehicles. In this way, safety can be restored particularly comprehensively and efficiently.

In a preferred embodiment of the present invention, it is provided that the emergency stop switch(es) cyclically send first signals comprising unique identity information and current state information, in particular “actuated” or “not actuated,” to the information-providing computing unit. Further preferably, the information-providing computing unit may provide the current, particular state information of one or more emergency stop switches, wherein the state information is provided in particular in a manner suitable for being displayed on an HMI (for example, a display).

According to the present invention, it is particularly preferred if the state information comprises a position of the particular emergency stop switch within the infrastructure. This allows infrastructure personnel, for example, to efficiently determine the position within the infrastructure where the emergency stop switch that caused an emergency stop is located. This is in particular advantageous when there is a large number of emergency stop switches.

According to a second aspect of the present invention, an infrastructure system for connected vehicles is provided. According to an example embodiment of the present invention, the infrastructure system comprises:
an infrastructure computing unit, which is designed to generate payload data, in particular data for controlling the connected vehicles within a defined infrastructure;
an information-providing computing unit, which is configured to receive the payload data from the infrastructure computing unit, to generate a message, in particular a vehicle message, by using the payload data, and to send the message;
one or more emergency stop switches, which are arranged within the infrastructure and are designed to send first signals to the information-providing computing unit;
a configuration unit having a database in which one or more lookup tables are stored, wherein each emergency stop switch is assigned a lookup table, and wherein the configuration unit comprises:
   a current configuration definition of the infrastructure system, which, in particular, indicates which emergency stop switches are currently assigned to the infrastructure system;
   a transformation table created by means of the configuration definition, wherein the transformation table is created from the lookup tables, with knowledge of a target check table;
      wherein the information-providing computing unit is configured to retrieve the transformation table from the configuration unit and
      by means of the received first signals and the transformation table, to transform the payload data and send them to an infrastructure-connected vehicle.

According to a third aspect of the present invention, an infrastructure-connected vehicle is provided. According to an examine embodiment of the present invention, the infrastructure-connected vehicle is designed to be guided in an at least semi-automated manner within an infrastructure comprising an infrastructure system according to the second aspect. For this purpose, the vehicle comprises a computing platform for controlling actuators of the vehicle, which computing platform is configured to:
receive calculated payload data from the information-providing computing unit of the infrastructure system,
receive and/or read a check table,
evaluate the payload data by using the check table and check the validity of the payload data based on the check table;
upon determining invalidity, the actuators are controlled in such a way that a predefined safety maneuver is performed.

According to the present invention, a computing platform for controlling the actuators of a vehicle can accordingly be provided. For safely implementing an emergency stop function, an additional “data watchdog” can thus be introduced, which comprises evaluating a checksum. The checksum is created by using input data from emergency stop switches.

According to a fourth aspect of the present invention, a method for configuring an infrastructure system for connected vehicles according to the third aspect of the present invention. According to an example embodiment of the present invention, the method comprises the steps of:
providing for a defined number of emergency stop switches,
providing for a check table,
coupling each emergency stop switch to a unique lookup table,
by means of the lookup tables, creating a transformation table, taking into account the check table,
providing the transformation table and the check table.

Preferably, position information for all emergency stop switches is created and stored in such a way that the information-providing computing unit has access to these data so that the location of the actuated emergency stop switch can be displayed on a display/HMI.

An infrastructure system according to the present invention may, for example, be designed as an AVM or AVP system, where AVM stands for “automated vehicle maneuvering” and describes the semi-automated or fully automated guidance of a vehicle (e.g., a motor vehicle or a robot) in a defined environment, for example a production hall, a loading facility or a parking facility. AVP is a form of this, where AVP stands for “automated valet parking,” i.e., a system in which motor vehicles can be guided and parked in a semi-automated or fully automated manner within a defined environment.

The term “infrastructure-connected vehicle” includes vehicles, for example a motor vehicle or a robot, which has a suitable communication device with which the infrastructure-connected vehicle can exchange data with an infrastructure system. For this purpose, a wireless data connection is established, via which the infrastructure-connected vehicle can transmit and/or receive data. It can preferably be a radio connection, for example a mobile radio connection or a direct wireless connection. Such communication between an infrastructure-connected vehicle and another road user is also referred to as V2I or C2I communication.

The wording “at least semi-automated” covers one or more of the following cases: assisted guidance, semi-automated guidance, highly automated guidance, and fully automated guidance of a vehicle, for example of a motor vehicle or a robot.

Assisted guidance means that a driver of the vehicle continuously carries out either the lateral or longitudinal guidance of the vehicle. The other driving task (i.e., control of the longitudinal or lateral guidance of the vehicle) is performed automatically. This means that, with assisted guidance of the vehicle, either the lateral or the longitudinal guidance is controlled automatically.

Semi-automated guidance means that, in a specific situation (for example: driving on a freeway, driving within a parking lot, overtaking an object, driving within a lane defined by lane markings) and/or for a certain period of time, longitudinal and lateral guidance of the vehicle are automatically controlled. A driver of the vehicle does not have to manually control the longitudinal and lateral guidance of the vehicle themselves. However, the driver must continuously monitor the automatic control of the longitudinal and lateral guidance in order to be able to intervene manually if necessary. The driver must be prepared to fully take over the vehicle guidance at any time.

Highly automated guidance means that, for a certain period of time in a specific situation (for example: driving on a freeway, driving within a parking lot, overtaking an object, driving within a lane defined by lane markings), longitudinal and lateral guidance of the vehicle are automatically controlled. A driver of the vehicle does not have to manually control the longitudinal and lateral guidance of the vehicle themselves. The driver does not have to continuously monitor the automatic control of the longitudinal and lateral guidance in order to be able to intervene manually if necessary. If required, a prompt to take over the control of the longitudinal and lateral guidance is automatically output to the driver, in particular output with a sufficient time reserve. The driver therefore potentially has to be able to take over the control of the longitudinal and lateral guidance. Limitations of the automatic control of the lateral and longitudinal guidance are automatically detected. In highly automated guidance, it is not possible to bring about a state of minimal risk automatically in every starting situation.

Fully automated guidance means that in a specific situation (for example: driving on a freeway, driving within a parking lot, overtaking an object, driving within a lane defined by lane markings), longitudinal and lateral guidance of the motor vehicle are automatically controlled. A driver of the vehicle does not have to manually control the longitudinal and lateral guidance of the vehicle themselves. The driver does not have to monitor the automatic control of the longitudinal and lateral guidance in order to be able to intervene manually if necessary. Before the automatic control of the lateral and longitudinal guidance is terminated, the driver is automatically prompted to take over the driving task (controlling the lateral and longitudinal guidance of the vehicle), in particular with a sufficient time reserve. If the driver does not take over the driving task, a return to a state of minimal risk is automatically made. Limitations of the automatic control of the lateral and longitudinal guidance are automatically detected. In all situations, it is possible to return to a system state of minimal risk automatically.

Driverless control or guidance means that, independently of a specific application case (for example: driving on a freeway, driving within a parking lot, overtaking an object, driving within a lane defined by lane markings), longitudinal and lateral guidance of the vehicle are controlled automatically. A driver of the vehicle does not have to manually control the longitudinal and lateral guidance of the vehicle themselves. The driver does not have to monitor the automatic control of the longitudinal and lateral guidance in order to be able to intervene manually if necessary. The longitudinal and lateral guidance of the vehicle is thus controlled automatically, for example, for all road types, speed ranges and environmental conditions. The entire driving task of the driver is thus taken over automatically. The driver is therefore no longer required. The vehicle can thus drive even without a driver from any starting position to any desired destination position. Potential problems are solved automatically, i.e., without the help of the driver.

Remote control of the vehicle means that longitudinal and lateral guidance of the vehicle is controlled remotely. This means, for example, that remote control signals are sent to the vehicle for remotely controlling the lateral and longitudinal guidance. Remote control is performed, for example, by means of a remote control device.

### BRIEF DESCRIPTION OF THE DRAWINGS

Embodiments of the present invention are described in detail with reference to the figures.

FIG. 1 shows an infrastructure system according to an exemplary embodiment of the second aspect of the present invention, illustrating the performance of a method according to an exemplary embodiment of the first aspect, wherein a connected vehicle that is guided in an at least semi-automated manner within an infrastructure according to an exemplary embodiment of the third aspect.

FIG. 2 shows a method sequence according to an exemplary embodiment of the fourth aspect of the present invention and the first aspect of the present invention.

FIG. 3 shows an example of a possible design of the lookup tables, the transformation table and the check table, according to an example embodiment of the present invention.

### DETAILED DESCRIPTION OF EXAMPLE EMBODIMENTS

In the following description of the exemplary embodiments of the present invention, identical elements are denoted by the same reference signs, and repeated description of these elements may be omitted where appropriate. The drawings show the subject-matter of the present invention only schematically.

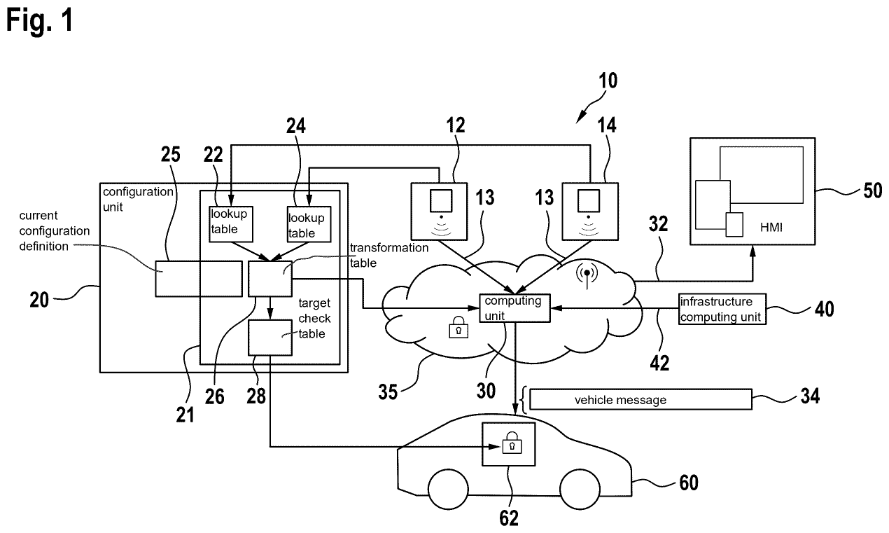

FIG. 1 shows an infrastructure system 10. The infrastructure system 10, which is designed, for example, as an AVP system, comprises two emergency stop switches 12 and 14, a configuration unit 20, an information-providing computing unit 30, an infrastructure computing unit 40, and an HMI (human-machine interface) system 50. A connected vehicle 60, which is designed to communicate wirelessly with the information-providing computing unit 30, is guided in an at least semi-automated manner within a defined infrastructure operated by the infrastructure system 10. The information-providing computing unit 30 can be formed, for example, in a cloud 35.

The infrastructure computing unit 40 is designed to generate payload data 42, in particular data for controlling the connected vehicle 30 within the defined infrastructure. If the infrastructure system 10 is an AVP system, the infrastructure computing unit 40 can, for example, assign a parking space to the vehicle 30 and calculate a route or trajectory for an at least semi-automated, preferably fully automated, drive of the vehicle 60 to and from the assigned parking space, and generate corresponding control commands for the vehicle.

The information-providing computing unit 30 is configured to receive the payload data 42 from the infrastructure computing unit 40, to generate a message, in particular a vehicle message 34, by using the payload data, and to send the message to the vehicle 60.

Two emergency stop switches 12 and 14 are arranged within the infrastructure, for example for manual actuation in an emergency. The emergency stop switches 12 and 14 are designed to send first signals 13, in particular cyclically, to the information-providing computing unit 30.

The configuration unit 20 comprises a database 21, in which an assigned lookup table 22, 24 is stored for each of the emergency stop switches 12 and 14. The database 21 furthermore comprises a current configuration definition 25 of the infrastructure system 10, which, in particular, indicates which emergency stop switches 12, 14 are currently assigned to the infrastructure system 10. Also stored is a transformation table 26 created by means of the current configuration definition 25, wherein the transformation table 26 is created from the lookup tables 22, 24, with knowledge of a target check table 28, which is likewise stored. The lookup tables 22, 24, for example, contain specific data that the particular emergency stop switch sends, for example, via a radio interface (Wi-Fi, 5G, . . . ) or a wired data connection.

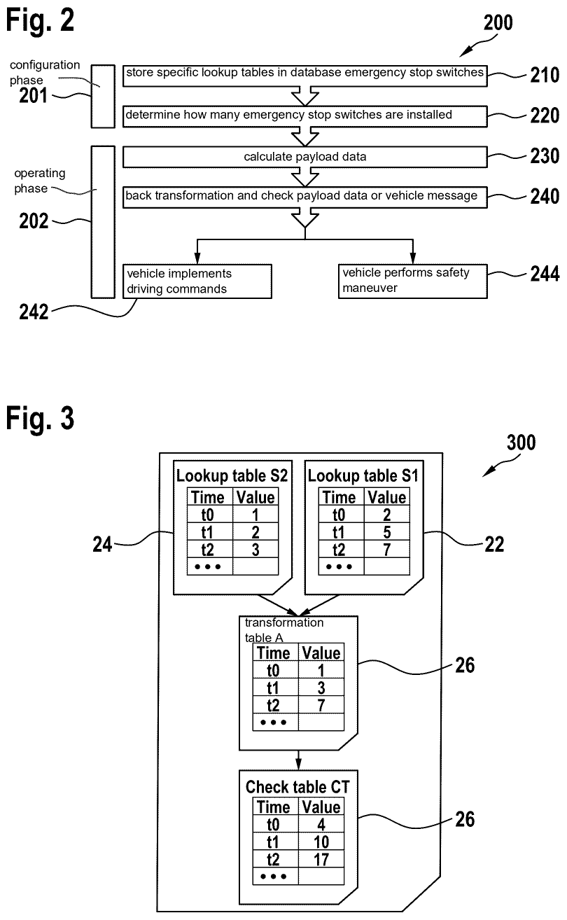

The data of the lookup tables 22, 24 may, for example, already be stored in the particular emergency stop switch 12, 14 upon delivery and may be assigned to the transformation table 26 via the type part number during configuration (see FIG. 2). Alternatively, the lookup tables 22, 24 may be downloaded during the initial commissioning of the particular emergency stop switch 12, 14 and/or retrieved from an external data source (not shown) and used by the emergency stop switches 12, 14 during operation.

The information-providing computing unit 30 is configured to retrieve the transformation table 26 from the database 21 and, by means of the first signals 13 received from the emergency stop switches 12, 14, and the transformation table 26, to transform the payload data 42 and to send them, for example as what is referred to as a vehicle message 34, to the infrastructure-connected vehicle 60.

The infrastructure-connected vehicle 60 comprises a computing platform 62 for controlling actuators of the vehicle 60, which computing platform is configured to receive calculated or transformed payload data from the information-providing computing unit 30 of the infrastructure system 10.

The check table 28 may be received and/or read, for example once, and stored within the computing platform 62.

The payload data are evaluated by using the check table 28, and the validity of the payload data is checked by using the check table 28.

Upon determining invalidity of the payload data, for example because one or both of the emergency stop switches 12, 14 have been actuated or are out of operation, the computing platform 62 may control the actuators of the vehicle 60 in such a way that a predefined safety maneuver is performed, for example an emergency stop.

Furthermore, it can be provided that the emergency stop switches 12, 14 cyclically transmit a unique identity (e.g., a serial number) as well as their current state (“actuated”/“not actuated”) to the information-providing computing unit 30. This allows the information-providing computing unit 30 to unambiguously determine which emergency stop switch was actuated. The information-providing computing unit 30 may now provide the information 32 as to which emergency stop switch 12, 14 was actuated. This information 32 may be displayed on an HMI 50, e.g., a (mobile) device, such as a tablet, smartphone, smartwatch or display of a manufacturing infrastructure. In addition, when the overall system is configured, position information for the emergency stop switches 12, 14 (e.g., GPS coordinates, floor information, markings on a map, . . . ) may be created and stored in such a way that the information-providing computing unit 30 has access to this position information. This means that the HMI 50 can directly display where the actuated emergency stop switch is located.

FIG. 2 shows a flowchart 200 of a method sequence according to a preferred exemplary embodiment of the present invention (using the example of the infrastructure system 10 of FIG. 1).

The sequence is divided into two portions 201, 202. The overall system may be manually configured in a rule-based manner during development or initial commissioning, and whenever changes are made.

In the configuration phase 201, in step 210, a specific lookup table 22, 24 is stored in a database 21 of the configuration unit 20 for each emergency stop switch 12, 14 present in an infrastructure system. The particular lookup table 22, 24 contains, for example, specific data that the particular emergency stop switch 12, 14 sends via a radio interface (Wi-Fi, 5G, . . . ).

In step 220, it is determined how many emergency stop switches are installed in the system, and an assignment is made in the system identifying which switches they are (e.g., by entering the type part numbers of the switches used). In the process, the switch information (in the form of lookup tables 12, 14) is linked to a transformation table 26. The transformation table is generated in such a way that a specified link between the lookup tables 12, 14 and the transformation table 26 leads to a result specified in a check table 28. The transformation table is transmitted or made available to the information-providing computing unit 30.

Steps 210 and 220 are carried out, for example, in the configuration unit 20. After completion of the configuration phase 201, the configuration unit 20 can be switched off.

In the operating phase 202, the calculation of payload data takes place in step 230. This comprises the information-providing computing unit 30 receiving first signals 13 from the emergency stop switches 12, 14. At the beginning of the communication, a handshake between the emergency stop switches 12, 14 and the information-providing computing unit 30 is necessary, which ensures that both processing steps start at the same time. The information-providing computing unit 30 receives/loads the data from the transformation table 26 (for safety reasons, the information-providing computing unit 30 should not have access to the check table 28) and calculates the payload data based on the first signals 13 of the emergency stop switches 12, 14 using the transformation table 26. The vehicle message 34 thus generated is sent to the vehicle 60. The system-configuration-dependent transformation table 26 ensures that messages with an unchanged transformation can be sent to the vehicle 60 even if changes are made in the overall system. This could be necessary, for example, if emergency stop switches are added and/or replaced and/or removed in the overall system. The payload data may be formed/present in the computing unit 62 itself or may be received externally, for example from the information-providing computing unit 30.

In step 240, the back transformation and check of the payload data or the vehicle message 34 is performed by the computing platform 62 for controlling the actuators of the vehicle 60. Said computing platform 62 receives the vehicle message 34 and receives/loads the data from the check table 28. The data in the check table 28 do not change even if the overall system changes. This is ensured by the transformation table 26, which is adapted as needed when changes occur.

The data from the check table 28 may, for example, be loaded into the vehicle 60 once at the factory or be continuously retrieved from the vehicle via a data interface (if required), or be specified by the vehicle manufacturer according to previously agreed rules. The necessary transformation of the data in the lookup tables 22, 24 may be carried out by adapting the transformation table 26.

The computing platform 62 evaluates the vehicle message 34 and checks the validity thereof. In this way, it is checked whether the emergency stop switches are functioning correctly and have not been actuated. Preferably, this validity check may be combined with an existing watchdog (e.g., for safety monitoring). If the check shows a match with the check table, it is assumed that none of the emergency stop switches 12, 14 has been actuated, and the vehicle 60 implements any driving commands optionally comprised in the payload data in step 242.

If the check is invalid, it may be concluded that the emergency stop switch 12, 14 has been actuated or, for example, that there is a malfunction or signal interruption between at least one of the emergency stop switches 12, 14 and the information-providing computing unit. In this case, in step 244, the vehicle 60 performs a previously defined safety maneuver (“minimal risk maneuver”). This means, for example, that the computing platform 62 transfers the vehicle 62 into a safe state (e.g., standstill).

FIG. 3 shows a simple example of a calculation rule showing how the transformation table 26 is formed from the input information from lookup table 22, lookup table 24 and check table 28. In the example shown, the signal values to be received by the emergency stop switches 12, 14 at each time t0, t1, t2, . . . (according to the lookup tables 22, 24) are added to one another. The corresponding entry (offset) of the transformation table is determined in such a way that, by adding the offset specified in the transformation table 26, the target value for the check table 28 is reached at each time t0, t1, t2, . . . . For example, the emergency stop switches 12, 14 should send the values “2” and “5” at the time t1. For t1, the transformation table 26 is assigned an offset of “3,” so that, upon addition, the target value according to check table 28 for t1 is “10.” This calculation rule is provided solely to illustrate the approach and may be formed in any other mathematical manner (e.g., multiplication, etc.).

1-10. (canceled)

11. A method for an emergency stop function for infrastructure-connected vehicles, the method comprising:
creating, by a configuration unit, a transformation table from lookup tables corresponding to a current system configuration, with knowledge of a target, configuration-independent check table;
executing, by an information-providing computing unit, the following steps:
a) receiving and/or reading the transformation table from the configuration unit,
b) receiving first signals of one or more emergency stop switches from an infrastructure,
c) transforming a set of payload data based on the first signals and using the transformation table, and
d) sending the transformed payload data to a computing platform of an infrastructure-connected vehicle; and
executing, by at least one computing platform assigned to an infrastructure-connected vehicle for controlling actuators of the infrastructure-connected vehicle, the following steps:
e) receiving the transformed payload data from the information-providing computing unit,
f) providing the configuration-independent check table,
g) back-transforming the transformed payload data by using the configuration-independent check table, and checking validity of the payload data, and
h) upon determining invalidity of the payload data, performing a predefined safety maneuver.

12. The method according to claim 11, wherein the predefined safety maneuver comprises an immediate stopping of the infrastructure-connected vehicle.

13. The method according to claim 11, wherein the one or more emergency stop switches cyclically send the first signals including unique identity information and current state information to the information-providing computing unit.

14. The method according to claim 13, wherein the current state information includes “actuated” or “not actuated.”

15. The method according to claim 13, wherein the information-providing computing unit provides the current state information for each emergency stop switch of the one or more emergency stop switches, wherein the current state information is suitable for being displayed on a human-machine interface (HMI).

16. The method according to claim 13, wherein the current state information includes a position of an emergency stop switch of the one or more emergency stop switches within the infrastructure.

17. An infrastructure system for connected vehicles, comprising:
an infrastructure computing unit configured to generate payload data including data for controlling the connected vehicles within a defined infrastructure;
an information-providing computing unit configured to receive the payload data from the infrastructure computing unit, to generate a message including a vehicle message, by using the payload data, and to send the message;
one or more emergency stop switches arranged within the infrastructure and configured to send first signals to the information-providing computing unit;
a configuration unit having a database including one or more lookup tables, wherein each emergency stop switch of the one or more emergency stop switches is assigned a lookup table, and wherein the database includes:
a current configuration definition of the infrastructure system, which indicates which emergency stop switches of the one or more emergency stop switches are currently assigned to the infrastructure system, and
a transformation table created using the configuration definition, wherein the transformation table is created from the lookup tables, with knowledge of a target, configuration-independent check table;
wherein the information-providing computing unit is configured to retrieve the transformation table from the database, and, using received first signals and the transformation table, to transform the payload data and the transformed payload data to an infrastructure-connected vehicle.

18. An infrastructure-connected vehicle configured to be guided in an at least semi-automated manner within an infrastructure including an infrastructure system, the infrastructure system including:
an infrastructure computing unit configured to generate payload data including data for controlling connected vehicles within a defined infrastructure;
an information-providing computing unit configured to receive the payload data from the infrastructure computing unit, to generate a message including a vehicle message, by using the payload data, and to send the message;
one or more emergency stop switches arranged within the infrastructure and configured to send first signals to the information-providing computing unit;
a configuration unit having a database including one or more lookup tables, wherein each emergency stop switch of the one or more emergency stop switches is assigned a lookup table, and wherein the database includes:
a current configuration definition of the infrastructure system, which indicates which emergency stop switches of the one or more emergency stop switches are currently assigned to the infrastructure system, and
a transformation table created using the configuration definition, wherein the transformation table is created from the lookup tables, with knowledge of a target, configuration-independent check table;
wherein the information-providing computing unit is configured to retrieve the transformation table from the database, and, using received first signals and the transformation table, to transform the payload data and the transformed payload data to the infrastructure-connected vehicle;
the infrastructure-connected vehicle comprising:
a computing platform configured to control actuators of the vehicle, the computing platform being configured to:
receive the transformed payload data from the information-providing computing unit of the infrastructure system,
receive and/or read a check table,
back-transform the transformed payload data by using the check table and check the validity of the payload data based on the check table, and
upon determining invalidity, control the actuators of the vehicle in such a way that a predefined safety maneuver is performed.

19. The vehicle according to claim 18, wherein the computing platform is configured to receive and/or read the transformation table.

20. A method for configuring an infrastructure system for connected vehicles, the method comprising the following steps:
a) providing for a defined number of emergency stop switches;
b) providing for a configuration-independent check table,
c) coupling each emergency stop switch to a unique lookup table,
d) creating, using the lookup tables, a transformation table taking into account the configuration-independent check table, and
e) providing the transformation table and the configuration-independent check table.

21. The method according to claim 20, wherein respective position information for all of the emergency stop switches is created and stored in such a way that an information-providing computing unit of the infrastructure system has access to particular position information so that a location of an actuated emergency stop switch of the emergency stop switches can be displayed in a human-machine interface (HMI).
